(19) United States
(12) Patent Application Publication
(10) Pub. No.: US 2016/0358521 A1
(43) Pub. Date: Dec. 8, 2016

(54) SELF ILLUMINATED SIGNAGE FOR PRINTED GRAPHICS WITH ORIENTED TURNING LAYER

(71) Applicant: 3M INNOVATIVE PROPERTIES COMPANY, St. Paul, MN (US)

(72) Inventors: Erik A. Aho, North St. Paul, MN (US); John C. Schultz, Afton, MN (US)

(21) Appl. No.: 15/170,960

(22) Filed: Jun. 2, 2016

Related U.S. Application Data
(60) Provisional application No. 62/171,413, filed on Jun. 5, 2015.

(51) Int. Cl. G09F 13/02; G09F 13/16

(52) U.S. Cl. CPC G09F 13/02; G09F 13/16

(57) ABSTRACT

Self illuminated back and front lit signage for a printed graphic. The signage includes a turning film having a structured surface for redirecting light oriented on a first axis, a diffuser providing for diffusion, and a printed graphic oriented on a second axis. The first and second axis differ by at least 5°. The turning film receives light from an ambient light source and directs the light via the structured surface toward a viewer of the graphic in order to passively illuminate the signage.

### CROSS REFERENCE TO RELATED APPLICATIONS

This application claims priority from U.S. Provisional Application Ser. No. 62/171,413, filed Jun. 5, 2015, the disclosure of which is incorporated by reference in its/their entirety herein.

### BACKGROUND

Printed graphics have been used for advertising, safety, and personal uses for many years. These displays have become so commonplace that it may often be difficult to have a message noticed in a crowd of such signs. One common solution to this occurrence is to actively backlight a digital or static graphic in order to attract more attention. However, this active backlighting can come at a cost of requiring more energy and electronics, and producing more heat in a given environment, all of which may not be desirable. Certain approaches to ambient light illuminated signage are described in, e.g., U.S. Pat. No. 8,915,002 “Self Illuminated Signage for Printed Graphics”; US Pat. Application Publication No. 2014/325,882 “Self Illuminated Shaped and Two-sided Signage for Printed Graphics”; and US Pat. Application Publication No. 2015/068080 “Self Illuminated Signage for Printed Graphics.”

### SUMMARY

A self illuminated back lit sign, consistent with the present invention, includes a turning film having a structured surface for redirecting light, a diffuser providing for diffusion in at least one direction, a reflector on the non-structured surface of the turning film, and a graphic on or proximate the diffuser. The turning film has a feature axis, and the graphic has a horizontal viewing axis. The feature axis and the horizontal viewing axis differ by at least 5°. This axis offset allows the sign to perform well in lighting conditions where the light source may not be located directly overhead. The turning film directs light via the structured surface toward a viewer of the graphic in order to passively illuminate the sign, even when the ambient light source is not located directly above the sign.

Methods of manufacturing and installing such a sign are also described.

### BRIEF DESCRIPTION OF THE DRAWINGS

The accompanying drawings are incorporated in and constitute a part of this specification and, together with the description, explain the advantages and principles of the invention. In the drawings,

FIG. 1 is a side sectional view of self illuminated back lit signage;

FIG. 2 is a diagram illustrating ray tracing for the signage of FIG. 1;

FIG. 3 is a side sectional view of self illuminated front lit signage;

FIG. 4 is a side sectional view of an alternative construction of the signage of FIG. 3; and

FIG. 5 is a diagram illustrating ray tracing for the signage of FIG. 3.

FIG. 6 is a plan view of a sample of turning film.

FIG. 7 is a graphic sign.

FIG. 8 is a front lit illuminated sign.

FIG. 9 is a drawing showing various angle orientations of a sign and the turning film in the sign.

FIG. 10 is a front lit illuminated sign having its turning film at an orientation angle that is different from the graphic sign.

FIG. 11 is a drawing showing various angle orientations of a sign and the turning film in the sign.

FIG. 12 is an apparatus for determining the angle of good lighting at an installation location.

FIG. 13 is a drawing showing various measured angles of light using the apparatus of FIG. 12.

FIG. 14 is a method for manufacturing a front lit illuminated sign.

### DETAILED DESCRIPTION

Embodiments of this invention utilize ambient lighting or remotely located lighting to give a viewer the perception that a graphic has a powered backlight attached to it. In particular, the signage uses a turning film and one or more diffusers providing controlled diffusion in order to direct light toward the viewer of the graphic. This graphic signage can be used in a variety of ways such as with banner applications, advertising, point of purchase signage, traffic signage, or any sort of graphic in which it may be desirable to light the graphic without an active powered backlight

### Back Lit Signage

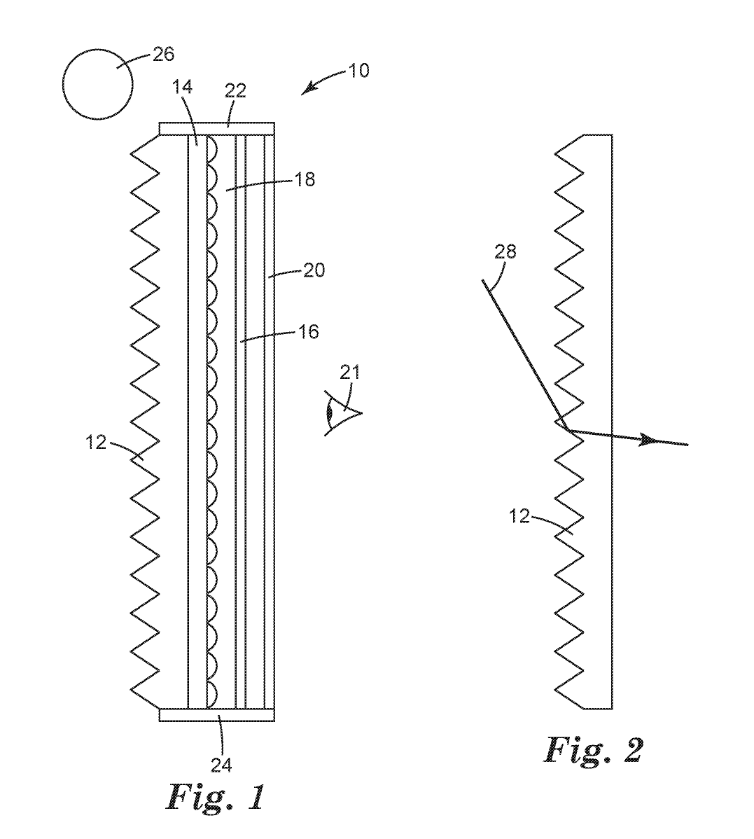

FIG. 1 is a side sectional view of self illuminated back lit signage 10. Signage 10 includes a turning film 12, a first diffuser 14, a second diffuser 16, and a graphic 20. Signage 10 optionally includes an air gap 18 between diffusers 14 and 16. Alternatively, diffusers 14 and 16 can be in physical contact or, instead of an air gap, can be separated by an optically clear material. The films or components of signage 10 can optionally be held together and edge sealed by tape or frame 22 and 24, which typically surrounds the edges of the films. Graphic 20 can be printed on diffuser 16 or printed on a transparency applied to, for example laminated on, diffuser 16.

Turning film 12 can be implemented with a 60° prism film, for example, or other types of light redirecting films having a structured surface for redirecting light. Diffusers 14 and 16 can be implemented with lenticular diffusing films, for example, with the lenticulars facing toward or away from a viewer of graphic 20. The optional air gap 18 can help prevent damage to the lenticulars when lenticular diffusing films are used for the diffusers. The air gap also provides a refractive index difference. Diffuser 14 provides for diffusion in at least one direction while diffuser 16 provides for diffusion in a different direction. When implemented with a lenticular diffusing film, diffuser 14 preferably has the lenticulars extending in the same direction substantially parallel with the prisms of turning film 12. Preferably, diffusers 14 and 16 provide for diffusion in orthogonal directions, as illustrated in FIG. 1, to provide for better uniformity of illuminating graphic 20. Instead of two diffusers, only one diffuser 14 or 16 can alternatively be used. Also, diffusers 14 and 16 can be replaced by a single asymmetric diffuser. The lenticulars of diffusing film 14 can optionally be registered with the prisms of turning film 12, which can provide for more gain. A system for registering microreplicated features on opposite sides of a film is disclosed in U.S. Pat. No. 7,165,959, which is incorporated herein by reference as if fully set forth.

In use, the features (triangular prisms) in turning film 12 direct light from light source 26, such as a room light, to graphic 20 in order to passively illuminate the signage for a viewer 21. FIG. 2 is a diagram illustrating ray tracing for the signage of FIG. 1, represented by line 28 showing how turning film 12 directs light from room light 26 to graphic 20 and viewer 21 for the passive illumination.

### Front Lit Signage

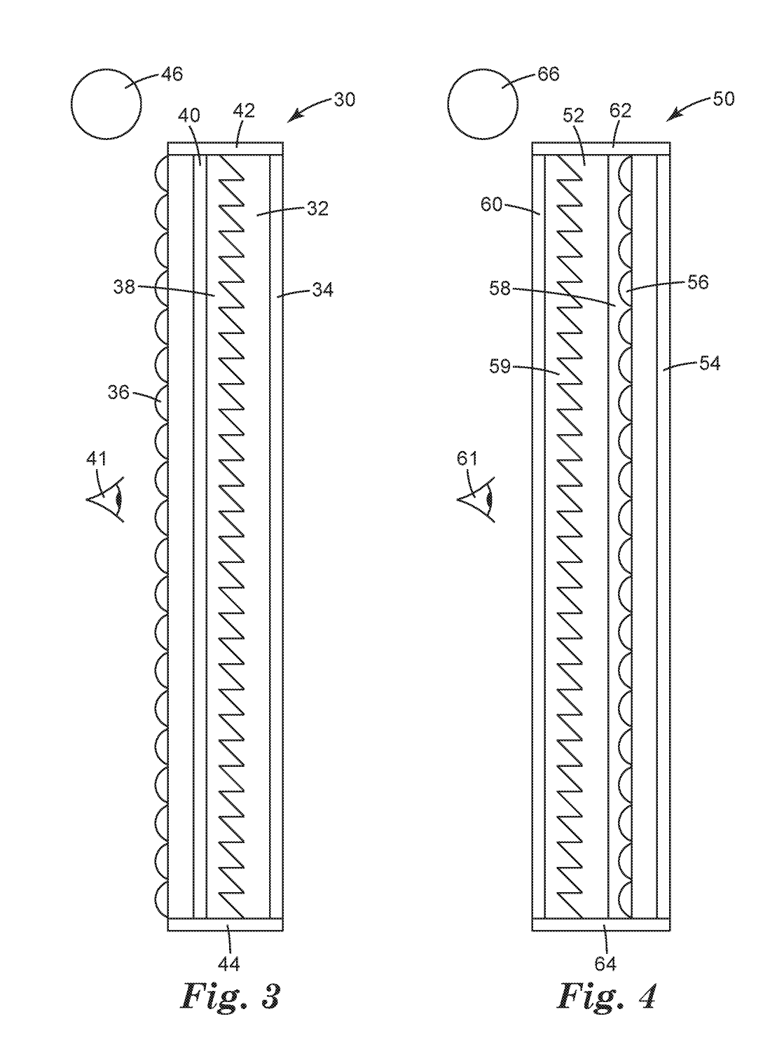

FIG. 3 is a side sectional view of self illuminated front lit signage 30. Signage 30 includes a turning film 32, a reflector 34, a diffuser 36, and a graphic 40. Signage 30 optionally includes an air gap 38 between turning film 32 and graphic 40. Alternatively, turning film 32 and graphic 40 can be in physical contact or, instead of an air gap, can be separated by an optically clear material. The films or components of signage 30 can optionally be held together and edge sealed by tape or frame 42 and 44, which typically surrounds the edges of the films. Graphic 40 can be printed on diffuser 36 or printed on a transparency applied to, for example laminated on, diffuser 36.

Turning film 32 can be implemented with a sawtooth prism film, for example, or other type s of light redirecting films having a structured surface for redirecting light. For example, a linear Fresnel film can be used instead of a sawtooth prism film. Reflector 34 can be implemented with a specular reflector, for example the Enhanced Specular Reflector (ESR) film from 3M Company. In some cases the specular reflector can be structured so as to provide a limited amount of angular spreading. Specular reflectors with structure include, for example, metalized microstructured films. In some cases the reflector can be semi-specular in nature where the reflector provides a small amount of spreading or limited amount of diffusion for light incident on the reflector. Semi-specular reflectors include, for example, a lightly diffuse coating on ESR film. Diffuser 36 can be implemented with a lenticular diffusing film, for example, with the lenticulars arranged at 45° with respect to the prisms of turning film 32. When implemented with a lenticular diffusing film, the lenticulars can face toward or away from a viewer of graphic 40. Instead of a lenticular diffusing film, diffuser 36 can be implemented with an asymmetric diffuser. The optional air gap 38 can help prevent damage to the prisms of turning film 32. The air gap also provides a refractive index difference.

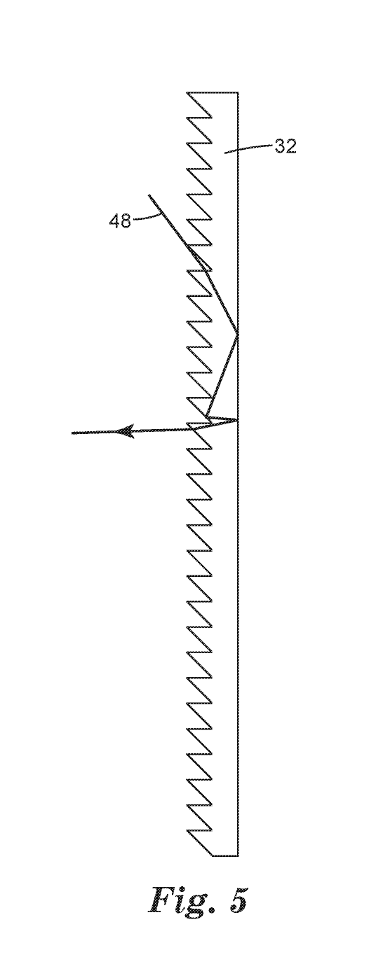

In use, the features (for example sawtooth prisms) in turning film 32 direct light from light source 46, such as a room light, to graphic 40 in order to passively illuminate the signage for a viewer 41. FIG. 5 is a diagram illustrating ray tracing for the signage of FIG. 3, represented by line 48 showing how turning film 32 directs light from room light 46 to graphic 40 and viewer 41 for the passive illumination.

FIG. 4 is a side sectional view of front lit self illuminated signage 50, which is an alternative construction of signage 30. Signage 50 includes a turning film 52, a reflector 54, a diffuser 56, and a graphic 60. Signage 50 can also include an optional air gap 58 between turning film 52 and diffuser 56, and an optional air gap 59 between turning film 52 and graphic 60. An optional edge tape or frame 62 and 64 can be used around the edges of signage 50. In this alternative construction, the diffuser is placed behind the turning film (between the reflector and turning film) with graphic 60 remaining in front of the turning film from the viewer's perspective. In this alternative construction, the diffuser can be attached to the turning film through lamination or a microreplication process with the back side of the diffuser metalized to eliminate the need for a separate reflector. The components of signage 50 can be implemented with the components identified above for signage 30. In use, turning film 52 directs light from a light source 66 to graphic 60 and a viewer 61 in order to passively illuminate the signage.

For the signage described above, the remotely located or ambient light may be oriented either in front of or behind the graphic and possibly at a high angle depending on the specific signage design. The light sources (26, 46, 66) for the signage are shown proximate the signs for illustrative purposes only; the light sources can be located at a variety of positions and distances in front of the sign for front lit signs or behind the signs for back lit signs, including positioned at various angles with respect to the signs. Aside from or in addition to room lighting, the light source can include sunlight from a window, for example. The light source can also include a large area collimated light source. The signage is self illuminated, meaning it uses passive illumination and does not contain its own active light source.

For the self illuminated signage, when a film or component is recited as being on another film or component, the film or component can be directly on (in physical contact with) the other film or component, adjacent but not in physical contact with the other film or component, or partially directly on and partially adjacent the other film or component.

The signage including the graphic can be substantially planar, as shown, or optionally curved. For curved signage, the optional frame can be curved to hold the films of the signage in a curved arrangement. The graphic for the sign can include, for example, text, logos, drawings, images, branded shapes, photos, or any other static information. The static information can be provided as a print on any type of substantially transparent and substantially non-diffusing substrate, for example polymeric films or transparent inorganic glass. In some embodiments the static information can comprise a solid color surface, which can optionally also be a structured surface. In some embodiments the static information can comprise a multi-color surface, which can optionally also be a structured surface. The information for the graphic is contained on the signage and is not projected onto it. However, the self illumination of the signage may provide the appearance of a projected image due to the lighting of the graphic. Also, depending upon the types of diffuser or other films used in the signage, the graphic may have the appearance of a 3D or floating image.

An alternative construction of the front lit sign can include the design described above except the sign can incorporate a curve in the repeated pattern in order to always have the active face of the features largely face the light source. The center of the radius of curvature of the repeated prism pattern can be such that it largely lies at the projected center of the light source located directly above the sign. This design can produce a single bright spot, indicating that the specular reflections are well controlled. A diffuser can be used to spread the output to a usable width. This construction can be used with a near source as the light source.

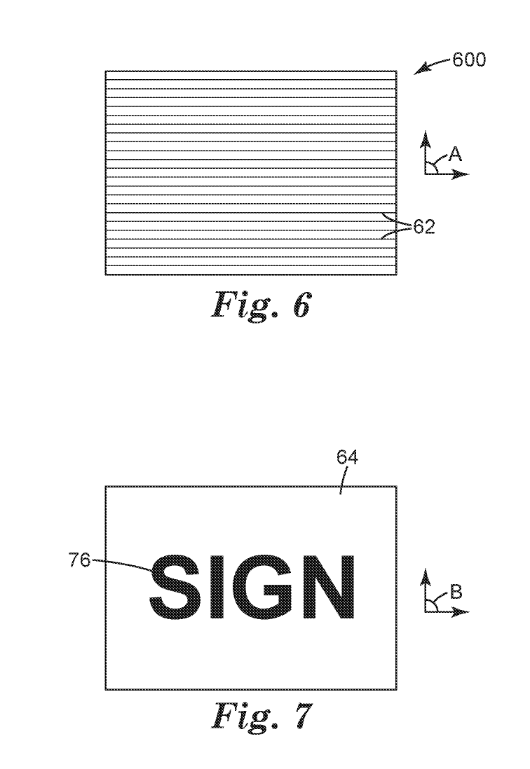

Another alternative construction of the front lit sign can include modifying the orientation of the turning film versus the printed graphic sign to achieve good front lit ambient lighting effects given various ambient lighting conditions. To better understand this alternative construction, it is helpful to first review an ordinary front-lit sign, of the type illustrated, for example, in embodiments associated with, e.g., FIG. 3. FIG. 6 shows turning film 600, which is turning film 32 (FIG. 3) in plan view, rather than profile. It is essentially the construction shown in FIG. 3, including reflector 34, but not including other elements of the construction, notably the graphic 40 and diffuser 36. The turning film comprises a plurality of long, slender (high aspect ratio) light redirecting features 62 running horizontally, in a regular, uniform distribution over the turning film 60. If turning film 600 were turned on its side, so as to be viewed in profile, the light redirecting features would embody a sawtooth pattern of the type shown in FIG. 3. The light redirecting features run parallel to one another. The light directing feature axis (“A” in the FIG. 6) for turning film 600 is 90° from normal.

Now turning to FIG. 7, consider graphic sign 64, which is to be passively illuminated by turning film 600. Graphic sign 64 includes a diffuser and a printed graphic of some kind. In certain embodiments, the graphic may be printed directly on the diffusive film, or a printed graphic film may be laminated by a diffuser (the latter shown in the embodiment described in FIG. 3). Other orientations or product configurations are also possible. Also possible are other intervening layers, including clear or partially clear protective film layers, coatings, or adhesive layers. Graphic sign 64 has an intended installation orientation, relative to the intended viewer. For example, graphic film 64's intended installation orientation is to have the letters oriented horizontally, in one case this means level. In other cases “horizontal” configurations may include wording or features that aren't necessarily level—horizontal in such case refers to the sign having an intended top, bottom, and left and right sides, and the horizontal configuration refers to sign embodiments where there is an intended left and right side (contrast such with, e.g., graphics of balls or dots where there may be no implicit correct horizontal orientation). In cases where the sign isn't rectangular, or is intended to be installed non-level, the sign may still have an intended horizontal orientation and should be configured such that certain points on the left and right side are level (which doesn't necessarily mean the top or bottom sign edge, if applicable, is level). The horizontal orientation of most rectangular signs is usually a given, because they are intended to be oriented such that the edges of the physical sign is level, as is the case with graphic film 64, which has a horizontal viewing axis, “B”, that is the difference in the intended horizontal viewing plane from normal, or in the case of the embodiment shown in FIG. 7, 90°.

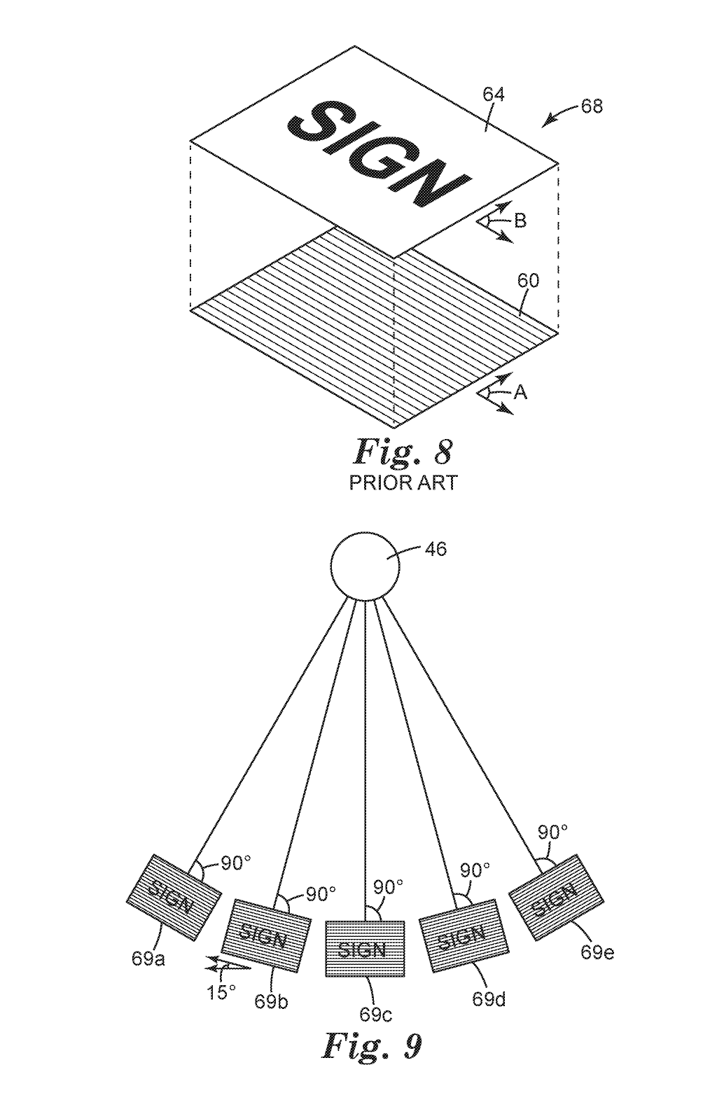

FIG. 8, then, shows how graphic sign 64 and turning film 600 would be coupled together to form common orientated front lit illuminated sign 68, as per the prior art. In this basic construction, the difference between the intended horizontal viewing axis of the graphic sign 64 and the turning film 60 is zero—(A is 90° and B is 90°).

Ideal orientations of signs constructed as described with respect to FIG. 8 may provide acceptable ambient lighting performance so long as, when installed in an intended viewing location, the lighting source is located directly above and out from the graphic sign, as shown in FIG. 9. Graphic signs 69a-e keep the horizontal viewing axis of the graphic sign and the feature axis aligned, and thus rotate the entire sign (including both the turning film and the printed graphic) around an imaginary axis that is the ambient lighting source. For some types of graphic signs, particularly those that may be so rotated without detrimental effects (e.g., a circular graphic sign of a baseball or a basketball), such rotation at the time of installation may be acceptable.

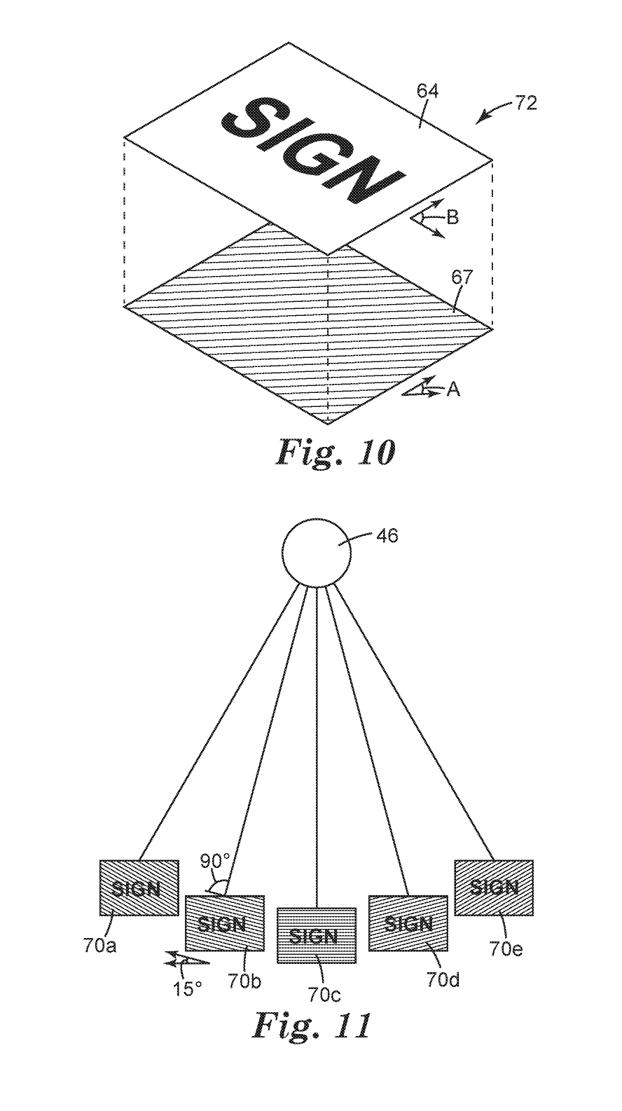

But for other types of graphic signs, it is not acceptable to rotate the whole sign in order to achieve the benefits of the front-lit films described herein. Instead, a newly discovered construction according to FIG. 10 is far more suitable. In FIG. 10, front lit ambient illuminated sign 72 has the same printed graphic 64, with a horizontal viewing axis B that is about 90° from normal, but the turning film 32 has been rotated so it will better align with the ambient lighting source at the installation location, so as to provide good ambient lighting results. Generally, such front lit signage should be oriented so that the light directing features are tangential to a circle centered on the light source or a region of the light source, so as to maximize the luminance of the sign in the desired viewing region for the desired orientation of the front lit signage. Thus the light directing feature axis of turning film 32 is rotated counter clockwise about 30° (A), while the intended sign orientation is kept at 90° from normal.

Turning now to FIG. 11, this 30° feature axis rotation would well accommodate, for example, graphic sign 70e, for which the lighting source is about 30° counterclockwise from normal. Graphic signs 70a-e show various positioning of signs, each having their turning film feature axis tailored to the ambient lighting conditions of the intended installation location. Various differences between the horizontal viewing axis (B) and the feature axis (A) are contemplated within the scope of this disclosure. In some embodiments, a difference of about 5° or more produces good results. In other embodiments, differences of 10°, 15°, even 20°, 25°, 30° or more may provide good results, based on the position of the front lit illuminated sign relative to the lighting source. (Note, the FIGS. 9 and 11 show point light source 46, such as an incandescent, LED, or cross-section of a fluorescent light. However, an extended light source, such as the length of a fluorescent lamp may also be used as the light source. In such case, the center of the extended light source is preferably treated as the point light source, which will provide a symmetric viewing region about the normal to the sign. Alternatively, some applications may benefit from an off-center location of the ALIS signage under the light source, for example in a situation in which a wall precludes off-axis viewing in one direction.)

To measure the offset angle at an intended viewing location, so as to properly manufacture an acceptably performing front lit graphic illuminated sign when the ambient lighting source is off axis from the sign, an installer may use a typical piece of illuminated signage, as per sign 68 shown in FIG. 8, approach the approximate location of the intended installation, and rotate the piece while a second installer watches from an intended viewing position. The installer may roughly estimate the offset angle in such a scenario, or he may mark the approximate angle and then use a protractor device to measure the angle. In a one person installer instance, the installer may use tape or a tacky substance to try the piece at various rotational angles, then walk to the intended viewing location to observe the performance, then rotate the piece further, etc., until a good performing orientation has been achieved.

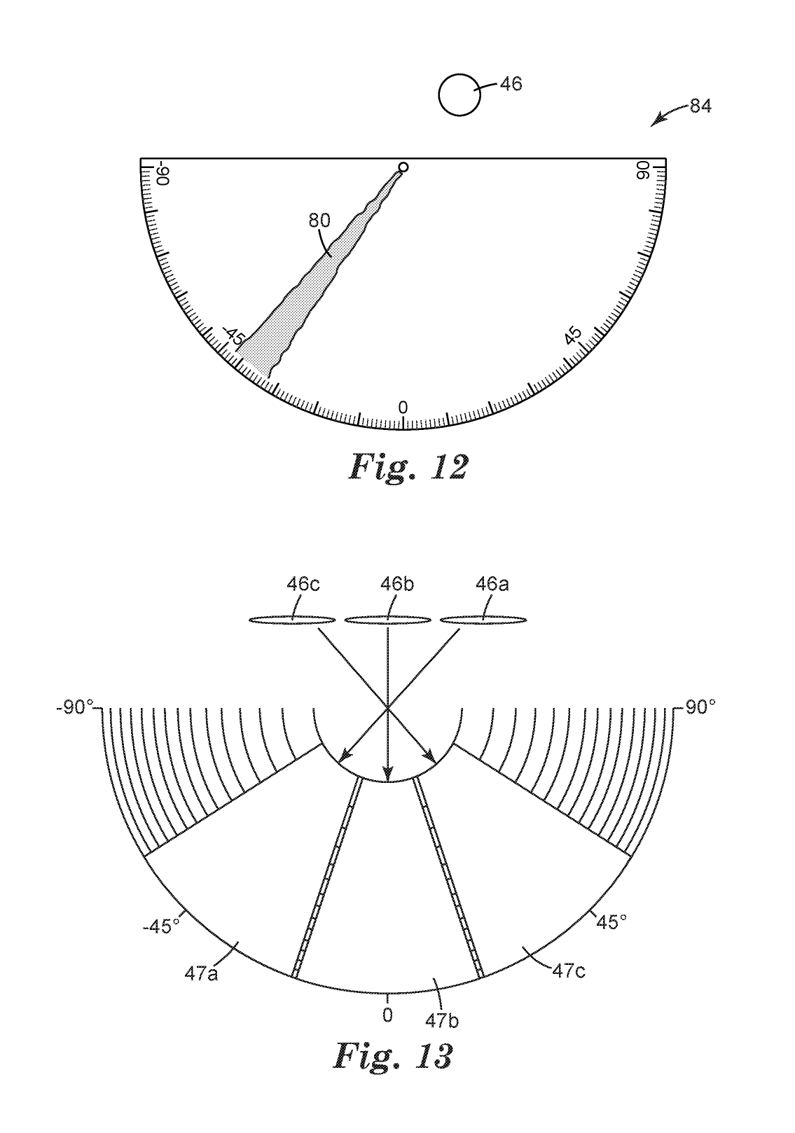

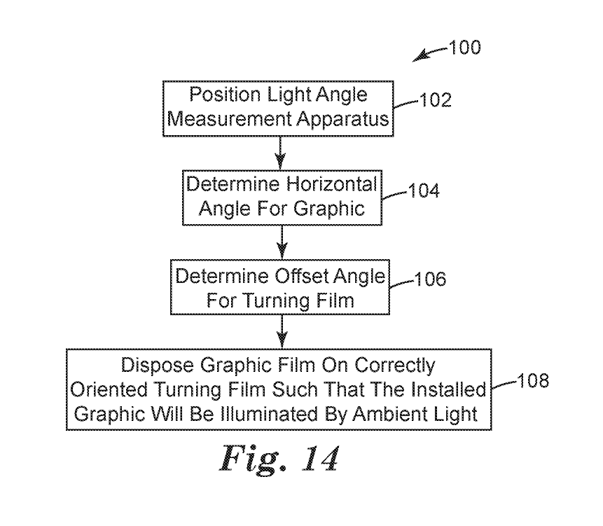

In another embodiment of an installation method, as show in FIG. 14, a light angle measurement apparatus may be temporarily fastened at the intended installation point. One suitable light angle measurement apparatus is shown in FIG. 12, which shows apparatus 84, which is a half Fresnel lens. Angle measurements have been helpfully inscribed or printed along the perimeter of the apparatus, or alternatively, protractor-like inscriptions on a separate film have been overlayed upon the Fresnel lens. Additionally, an optical diffuser may provide helpful when overlayed upon the Fresnel lens, preferably with properties similar or the same as the optical diffuser used in the front lit signage implementation. With the apparatus set in the proper position, the installer may go to the intended viewing location to measure lighting characteristics of the intended installation area. In FIG. 12, light 46 would look like a bright area 80, indicating the angle toward the light source 46.

The installer, having determined a suitable offset angle, would then fabricate a sign and turning film, both having an appropriately considered horizontal viewing axis (for the graphic sign) and feature axis (for the turning film). Assuming a typical horizontally oriented sign, the installer may determine a good feature axis angle for the turning film is, for example, −50° from horizontal or about −40° from normal, as shown in FIG. 12. Note that on this installation apparatus, degree offsets from normal are positive (to the right, up to 90°), or negative (to the left, up to 90°)—other systems could be used also. A light source directly above the installation indication would be indicated on the installation apparatus by a light area centered approximately around 0°. Multiple light sources would look something like what is illustrated in FIG. 13, indicating to the installer that several different offset angles may be utilized in subsequently fabricated graphic signage.

Returning now to FIG. 14, with a light angle measurement completed using the light angle measurement apparatus 84 (steps 102 and 104), the measurement is transmitted to the assembly facility. A cellular telephone camera is a good way of facilitating this transfer, by taking a picture of the light angle measurement apparatus from the perspective of the viewer. The installer would then determine the horizontal viewing angle for the graphic (step 106). For many rectangular graphics, such step is easy and self-evident, and is often 0° from horizontal. The installer would then cut out the graphic signage and then use the angle measurement to rotate, clockwise or counterclockwise, the turning film and reflector layer based on the light angle measurements. The rotated turning film/reflector is then cut to fit the shape of the non-rotated printed graphic, and the two are laminated or otherwise fastened together. (Collectively, step 108). As mentioned earlier, the printed graphic may be printed on a diffusive layer, or a diffuser may be laminated on top of a graphic image printed on a light transmissive film (or vice versa). There may also be intervening layers not mentioned here, for example protective layers, adhesive layers, etc. An adhesive layer may then be applied to the rear, non-graphic containing side of the film stack, to the back side of the reflective layer for example, to facilitate easier installation. In some embodiments, there may be an air gap between the graphic sign, which may be printed directly on a diffuse film, and the features in turning film 32. An installer would install the sign at the location at which the light angle measurement was used in step 102. The resulting installed front lit ambient illuminated sign may appear substantially brighter and more noticeable to intended viewers, as if it were actively illuminated, projected, or back lit, even though it is only passively illuminated. Such front lit illuminated signage may be used directly under a light source, but also at an oblique angle up to 60° and possibly up to in excess of 90° to the light source, depending on turning film 32 rotation angle.

### EXAMPLES

Samples were made and tested to show the gain in brightness of self illuminated signs over vinyl signs. These examples are merely for illustrative purposes only.

### Test Methods

### Luminance Measurement

Samples were placed on edge in a room lit with artificial light. Luminance measurements were made using a Minolta Luminance Meter LS-100 (available from Konica Minolta Sensing Singapore Pte Ltd). A 10.2 cm diameter area without printing (no color) was measured for front lit examples. A 7.6 cm diameter area without printing (no color) was measured for backlit examples. Luminance values are expressed in units of cd/m² and recorded in Table 1. Gain was calculated by dividing the luminance value of the sample by the luminance value of the associated comparative white vinyl sample, and the results are recorded in Table 1.

### Graphic Layer

The graphic prints were created on 50.8 micron transparent vinyl film #180C- 151-114 and 50.8 micron white vinyl film #180C-151-010 (both available from 3M Company, St. Paul, Minn.) using a Mimaki UJV-160 UV large format printer (available from Mimaki USA, Suwanee, Ga.).

### Example 1

### Sample Construction Front Lit Sign

The following 20.3 cm by 27.9 cm films (arranged in the following order) were passed through a 3M 1174 Roll laminator (available from 3M Company, St. Paul, Minn.) at room temperature.

Lenticular diffuser consisting of microreplicated linear lens features with a radius of curvature of 0.054 mm and a pitch of 0.028 mm oriented at 45 degree on one side of 126 micron PET film with structured side up. The process to impart structure to one or both sides of a film is described in U.S. Pat. No. 7,224,529.

Optically clear adhesive transfer tape, 8171, 25.4 micron thickness, available from 3M Company, St. Paul, Minn.

Graphic print on transparent vinyl as noted above with ink side to adhesive.

Turning film consisting of microreplicated 60 degree steps, 0.0825 mm on one side of 126 micron PET film with structured side up.

Optically clear adhesive transfer tape, 8171, 25.4 micron thickness, available from 3M Company, St. Paul, Minn..

VIKUITI ESR film, available from 3M Company, St. Paul, Minn.

This film stack was then sealed around all four edges with 3M F 9460PC VHB Adhesive Transfer Tape, available from 3M Company, St. Paul, Minn. The sample was tested for luminance using the test method described above. The lenticular diffuser surface of the film stack was facing the measurement device. Results are recorded in Table 1.

### Comparative Example 1

### Sample Construction Front Lit Sign

A sign was made using graphic print on white vinyl as noted above. The sample was tested for luminance using the test method described above. The ink surface of the film was facing the measurement device. Results are recorded in Table 1.

### Example 2

### Sample Construction Front Lit Sign

A sign was constructed the same as Example 1 but with an additional layer of optically clear adhesive transfer tape, 8171, 25.4 micron thickness (available from 3M Company, St. Paul, Minn.) between the graphic print and the turning film. The sample was tested for luminance using the test method described above. The lenticular diffuser surface of the film stack was facing the measurement device. Results are recorded in Table 1.

### Example 3

### Sample Construction Back Lit Sign

The following 20.3 cm by 27.9 cm films (arranged in the following order) were passed through a 3M 1174 Roll laminator (available from 3M Company, St. Paul, Minn.) at room temperature.

254 micron thick PET film.

Registered 2 sided turning film, prism side facing up (see FIG. 1), on 76 micron PET film, which is described as double sided prism film in U.S. Pat. No. 7,224,529.

Graphic print on transparent vinyl as noted above with ink side down.

Optically clear adhesive transfer tape, 8171, 25.4 micron thickness, available from 3M Company, St. Paul, Minn.

X axis lenticular diffuser consisting of microreplicated linear lens structures with a radius of curvature of 0.471 mm and a pitch of 0.254 mm on one side of 76 micron PET with structure side up.

This film stack was then sealed around all four edges with 3M F 9460PC VHB Adhesive Transfer Tape, available from 3M Company, St. Paul, Minn. A 61 cm by 91 cm mirror was placed under and behind the sign. The mirror was placed facing up. The sample was tested for luminance using the test method described above. The X axis lenticular diffuser surface of the film stack was facing the measurement device. Results are recorded in Table 1.

### Comparative Example 2

### Sample Construction Back Lit Sign

A sign was made using graphic print on white vinyl as noted above. The sample was tested for luminance using the test method described above. The ink surface of the film was facing the measurement device. Results are recorded in Table 1.

### Example 4

### Sample Construction Back Lit Sign

The following 35.5 cm by 104.1 cm films (arranged in the following order) were passed through a 3M 1174 Roll laminator (available from 3M Company, St. Paul, Minn.) at room temperature.

Turning film consisting of microreplicated 60 degree steps, 0.047 mm on one side of 76 micron PET film with structured side facing up.

Optically clear adhesive transfer tape, 8171, 25.4 micron thickness, available from 3M Company, St. Paul, Minn.

X axis lenticular diffuser consisting of microreplicated linear lens structures with a radius of curvature of 0.471 mm and a pitch of 0.254 mm on one side of 76 micron PET film with structure side down.

Y axis lenticular diffuser consisting of microreplicated linear lens structures with a radius of curvature of 0.471 mm and a pitch of 0.254 mm on one side of 76 micron PET film with structure side up.

Optically clear adhesive transfer tape, 8171, 25.4 micron thickness, available from 3M Company, St. Paul, Minn.

Graphic print on transparent vinyl as noted above with ink side down.

This film stack was then sealed around all four edges with 3M F 9460PC VHB Adhesive Transfer Tape, available from 3M Company, St. Paul, Minn. The sample was tested for luminance using the test method described above. The graphic print ink surface of the film stack was facing the measurement device. Results are recorded in Table 1.

### Comparative Example 3

### Sample Construction Back Lit Sign

A sign was made using graphic print on white vinyl as noted above with ink side out. The sample was tested for luminance using the test method described above. The ink surface of the film was facing the measurement device. Results are recorded in Table 1.

TABLE 1
Luminance and Gain

| Sample # | Luminance (cd/m²) | Gain |
|---|---|---|
| Example 1 - Front Lit | 490 | 3.27 |
| Example 2 - Front Lit | 412 | 2.75 |
| Comparative Example 1 | 150 | 1.00 |
| Example 3 - Back Lit | 450 | 4.74 |
| Comparative Example 2 | 95 | 1.00 |
| Example 4 - Back Lit | 370 | 3.88 |
| Comparative Example 3 | 95.3 | 1.00 |

1. A self-illuminated front lit sign, comprising a film layer stack arranged in the following order:
a graphic layer comprising a diffuser and a printed graphic, the printed graphic having a horizontal viewing axis;
a turning film layer having a first structured surface for redirecting light, and a second surface opposite the first surface, the first structured surface comprising a plurality of elongated, sawtooth, light directing features disposed parallel to a feature axis; and,
a reflective layer comprising a reflector;
wherein the turning film directs light via the first structured surface from in front of the sign toward a viewer of the graphic in order to passively illuminate the sign;
and further wherein the difference between the horizontal viewing axis and the feature axis is at least 5°.

2. The self-illuminated front lit sign of claim 1, wherein the difference between the horizontal viewing axis and the feature axis if at least 10°.

3. The self-illuminated front lit sign of claim 2, wherein the difference between the horizontal viewing axis and the feature axis is greater than at least 5°, and less than 45°.

4. The self-illuminated front lit sign of claim 1, wherein the horizontal viewing axis is level.

5. The self-illuminated front lit sign of claim 1, further comprising an air gap between the graphic layer and the and the turning film.

6. The self-illuminated front lit sign of claim 1, comprising further intervening layers between the graphic layer, the turning film layer, and/or the reflector layer.

7. The self-illuminated front-lit sign of claim 1, wherein the diffuser comprises an asymmetric diffuser.

8. The self-illuminated front-lit sign of claim 1, wherein the film layer stack is laminated

9. A method of making a self-illuminated front lit sign, comprising:
at an installation location where the self-illuminated front lit sign is to be installed, positioning a light angle measurement apparatus;
determining, using the light angle measurement apparatus, an offset angle measurement greater than 5 degrees from normal;
based on the offset angle measurement, disposing a graphic printed diffusive film layer having an intended horizontal viewing axis upon a structured surface side of a self-illuminated front lit film comprising a turning film having elongated light directing sawtooth features disposed parallel to a feature axis on the structured surface side, and a second side opposite the structured surface side;
and wherein the graphic printed diffusive film layer's intended horizontal viewing axis is at least 5° different than the feature axis;
and wherein the turning film directs light via the structured surface side of the self-illuminated front lit film toward a viewer of the graphic in order to passively illuminate the sign.

10. The method of claim 9, wherein the self-illuminated front lit film additionally comprises a reflective layer disposed proximate the second side.

11. The method of claim 9, wherein the offset angle measurement is a function of the intended position of the sign relative to an intended light source that will passively illuminate the sign.
